(19) United States
(12) Patent Application Publication
(10) Pub. No.: US 2015/0086123 A1
(43) Pub. Date: Mar. 26, 2015

(54) Photo Grouping System, Photo Grouping Method- and Non-Transitory Computer-Readable Storage Medium

(71) Applicant: Institute for Information Industry, Taipei (TW)

(72) Inventors: Tai-Chun Wang, New Taipei City (TW); Ping-I Chen, Taipei City (TW)

(73) Assignee: Institute for Information Industry, Taipei (TW)

(21) Appl. No.: 14/071,810

(22) Filed: Nov. 5, 2013

(30) Foreign Application Priority Data
Sep. 26, 2013 (TW) 102134809

(51) Int. Cl. G06K 9/62; G06F 17/30

(52) U.S. Cl. CPC G06K 9/6267; G06F 17/30247; G06K 9/6202
USPC 382/224

(57) ABSTRACT

A photo grouping system includes a photo database, a photo operating module, a photo grouping module, a landmark searching module, and a landmark determining module. The photo database saves a plurality of photos. The photo operating module converts the photos into a plurality of reference codes. The photo grouping module categorizes the photos into a plurality of photo groups according to the reference codes. The landmark searching module searches a landmark photo base on the photo groups. The landmark determining module determines the landmark names of the photo groups based on the landmark photos landmark searching module searched.

### RELATED APPLICATIONS

This application claims priority to Taiwan Application Serial Number 102134809, filed Sep. 26, 2013, which is herein incorporated by reference.

### BACKGROUND

1. Field of Invention

The present invention relates to a digital photo grouping system. More particularly, the present invention relates to a photo grouping system, a photo grouping method, and a non-transitory computer-readable storage medium.

2. Description of Related Art

The functions of the mobile devices are significantly improved, and mobile devices equipped with digital photographer are getting popular. Besides, most mobile devices are equipped with Global Positioning System (GPS) so digital photos taken by the mobile devices may include locations information to indicate where the photos were taken. The conventional photos auto grouping techniques are limited by the digital devices which take photos. If the photos are not taken by GPS-enabled mobile devices or digital camera, the photos are just grouped by the capture time.

If the photos are grouped by capture time, it is not easy to set the boundary of the time interval. For example, if users stay at the same scenic spot or landmark more than one day or visit several scenic spots or landmarks in a day to take photos, users cannot group all photos taken at one scenic spot or landmark to the same group by capture time. If these photos are grouped by capture time, all photos at the same scenic spot or landmark may not be grouped into the same group, or the same group includes the photos of a plurality of scenic spots or landmarks.

The conventional photo grouping devices and photo grouping method must be associated with GPS-enabled shot device so as to get location information; otherwise the photos cannot be grouped by location information. Thus, how to get unique reference code corresponding to each photo by image processing method and group the photos by these reference codes, and how to get geological identification from these photos which have been grouped are very important topics for research & design.

### SUMMARY

A photo grouping system, a photo grouping method, and a non-transitory computer-readable storage medium are provided. The present invention provides a photo grouping system, a photo grouping method, and a non-transitory computer-readable storage medium to solve the foregoing problems.

The present invention provides a photo grouping system including a photo database, a photo operating module, a photo grouping module, a landmark searching module, and a landmark determining module. The photo database saves a plurality of photos. The photo operating module converts the photos into a plurality of reference codes. The photo grouping module categorizes the photos into a plurality of photo groups according to similarity of the reference codes. The landmark searching module searches a landmark photo based on the photo groups, and the landmark determining module determines the landmark names of the photo groups based on the landmark photos which are searched by the landmark searching module.

The present invention provides a photo grouping method including: (a) saving a plurality of photos; (b) converting the photos into corresponding reference codes; (c) categorizing the photos into different photo groups based on similarity of the reference codes; (d) searching landmark photos based on these different photo groups; (e) determining landmark names of these photo groups based on searched landmark photos.

The present invention provides a non-transitory computer-readable storage medium for storing computer programs to execute a photo grouping method. The photo grouping method includes: saving a plurality of photos; converting the photos into the corresponding reference codes; categorizing the photos into the different photo groups based on similarity of the reference codes; searching landmark photos based on these different photo groups; and determining landmark names of these photo groups based on searched landmark photos.

In summary, the present invention has significant advantages and higher performance than current technology. With the present invention, we have significant improvement in photo grouping techniques, and it is worthwhile to be widely used and implemented in industry. Advantages of the present invention is to obtain unique reference code corresponding to each photo by image processing method so that the photos can be grouped by the reference codes and landmark names are also derived from the grouped photos.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a block diagram illustrating a photo grouping system according to one embodiment of the present invention;

FIG. 2 is a block diagram illustrating a photo operating module according to one embodiment of the present invention;

FIG. 3A is a schematic illustrating how the photo operating module converts the photos from the digital images codes into reference codes according to one embodiment of the present invention;

FIG. 3B is a schematic illustrating how the photo operating module measures similarity among the reference codes according to one embodiment of the present invention;

FIG. 4 is a flow chart illustrating a photo grouping method according to one embodiment of the present invention;

FIG. 5 is a flow chart illustrating a photo grouping method according to another embodiment of the present invention;

FIG. 6 is a flow chart illustrating how a photo grouping system and a grouping method are implemented according to one embodiment of the present invention; and

FIG. 7 is a flow chart illustrating how a photo grouping system and a grouping method are implemented according to another embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

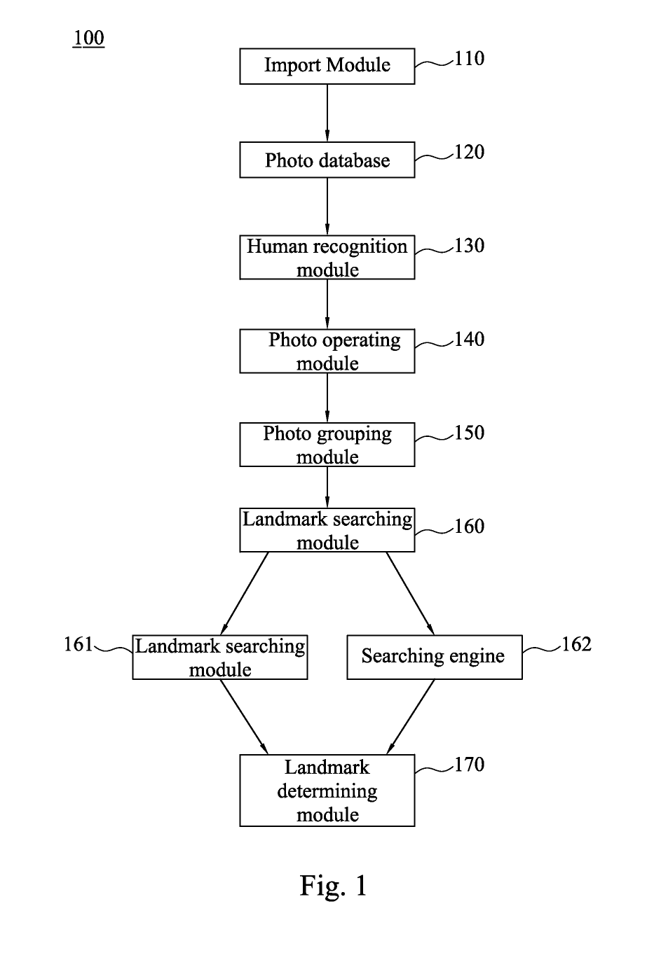

FIG. 1 is a block diagram illustrating a photo grouping system 100 according to one embodiment of the present invention. Referring to FIG. 1, according to one embodiment of the present invention, a photo grouping system 100 includes a photo database 120, a photo operating module 140, a photo grouping module 150, a landmark searching module 160, and a landmark determining module 170. The photo database 120 may be devices or apparatus such as cloud disk spaces or read-write memory devices for retaining or storing digital data. Users may upload the photos to the photo grouping system 100 via wired/wireless network, and the photo database 120 may save a plurality of photos which users upload. The photos are processed by way of the image analysis techniques and algorithm to know the parameters such as color histogram, color codes, image resolution, and brightness of the photos. The parameters may be converted into digital image codes. The digital image codes consist of a string of binary data such as “0” and “1”. Because a part or a plurality of parts of the binary string in the digital image codes are not significant or meaningless to distinguish one photo from others, these specific parts of the binary string in the digital image code each photo will be removed through the algorithm. The algorithm may be implemented in terms of software, hardware or combination. The digital image codes excluding the deleted (insignificant or meaningless) binary data may be used as the reference codes corresponding to each of the photos. The photo operating module 140 converts the digital image codes into several reference codes.

The reference codes of the photos may be different, however, while users use the same imaging device (e.g., a camera, a mobile device with a camera) to shoot scenery in vicinity of the same scenic spot, in particular to one building or one natural scenery, digital image codes corresponding to the photos taken at the same scenic spot are similar because parameters such as color histogram, color codes, image resolution, and brightness of the photos are similar. Thus, the reference codes which are converted from the digital image codes of the photos taken at the same spot are much similar, and similarity of the reference codes is high so that it is useful to categorize some of the photos having similar scenery by the reference codes. The photo grouping module 150 may categorize these photos into several groups according to similarity of the reference codes so that the photos of different scenery or scenic spots will be readily grouped.

Exchangeable image file format (EXIF) of the digital photo consists of photo attributes and imaging parameters such as date and time information, photo location, image resolution, aperture, exposure time, and image size. While digital images or photos are taken by GPS-enabled imaging device (e.g., a smart phone), the photo location of the digital images in EXIF can be used to recognize or identify the location where the digital images are taken. However, while the digital images or photos are taken by imaging devices without GPS (e.g., a digital camera), the capturing location will not be recorded in EXIF of the digital photos. Thus, the digital photos having known capturing locations are searched, and the new group of digital photos without capturing locations compares with the digital photos having known capturing locations, then the capturing locations are readily obtained. The landmark searching module 160 searches landmark photos based on this group of digital photos. The landmark determining module 170 determines the landmark names corresponding to the group of digital photos based on the landmark photos which are recognized and provided by the landmark searching module 160. Presently, some searching engines (e.g., Google) have been developed the technique to search by image. The photo that replaces keyword is uploaded to the searching engine, and the searching engine searches the similar images or photos which are pre-defined at searching engine database or over the internet. Besides, users can further get more information related to users' uploaded photos such as identified locations, peoples, merchants, etc. The photo grouping system 100 categorizes the photos into groups in advance, and with the photo searching techniques, the photo grouping system 100 uses one or more photos of these groups to search any photo or images which are pre-defined at searching engine database or over the internet and are similar to the photos of these groups. If the photos of these groups are scenery photos, then scenic spots or landmarks of the photos will be identified.

As mentioned above, the photo operating module 140, the photo grouping module 150, the landmark searching module 160, and the landmark determining module 170 may be implemented in terms of software, hardware/or firmware, and the software, hardware/or firmware may be integrated to central processing unit. For example, if execution speed and accuracy have top priority, then the photo operating module 140, the photo grouping module 150, the landmark searching module 160, and the landmark determining module 170 are mainly implemented in terms of hardware and/or firmware. If design flexibility has top priority, then the photo operating module 140, the photo grouping module 150, the landmark searching module 160, and the landmark determining module 170 are mainly implemented in terms of software. Alternately, these modules are implemented in terms of software, hardware and firmware and cooperates each other. It is noted that the foregoing examples or alternates should be treated equally, and the present invention is not limited to these examples or alternates. Anyone who is skilled in the prior art can make modification to these examples or alternates in flexible way if necessary.

According to one embodiment of the present invention, the photo grouping system 100 further includes an import module 110 which may be a photo import platform at web pages, an application program implemented at computer, an APP implemented at mobile device, or a multimedia kiosk at convenient stores. Users may utilize the import module 110 to import the photos, and the import module 110 may categorize the photos by date and time information of the photos in EXIF into groups. For example, the photos are categorized into groups by dates or months.

The photo database 120 saves the portrait photos and the scenery photos. Because the photo grouping system 100 determines the landmark of the photos through the landmark searching module 160 and the landmark determining module 170, the portrait photos which can be not identified the landmarks do not be analyzed immediately. Then, the portrait photos may be filtered out by human recognition techniques so that efficient searching of the landmark searching module 160 will be available. The photo grouping system 100 further includes a human recognition module 130 to detect human image of the photos by the edge detection algorithm, the skin color detection algorithm, and the ellipsoid method in sequence. The edge detection algorithm recognizes the boundary with drastic changes of grayscale after the human recognition module 130 uses the edge detection algorithm to identify where changes of color or surfaces are discontinuous. Because the skin of the human face forms a relatively tight cluster in color space, an ellipsoid mask is used to identify position of skin segments at the photos. The ellipsoid method compares the identified skin segments with the searched skin segments to determine whether the identified skin segments are part of the human faces. If the human face is detected, then a rectangular will be put around the human face so as to track the human face and calculate the center point. Based on size of the rectangular and clothing color below the human face, the human figure is detected and another rectangular will be put around the human figure. Thus, we can determine how much percentage of photo area the human figure does take. If the percentages of human figures to photo area of one or more photos exceed a predetermined percentage, then the portrait photos are not suitable for the landmark searching module 160 to recognize the landmarks. If the percentages of human figures to photo area of one or more photos exceed a predetermined percentage, then the human recognition module 130 may remove these portrait photos. That is, the photo operating module 140 does not convert these portrait photos into corresponding reference codes. While the photos are imported to the photo database 120 via the import module 110, the photos may be categorized by capture time of EXIF. Besides, the photos which have the percentages of human figures to photo area exceeding a predetermined percentage are categorized.

As recited the foregoing embodiment, the predetermined percentage is configured in the human recognition module 130. For example, the predetermined percentage is 50%. It is noted that any parameters configured in the human recognition module 130 may be modified or adjusted for practical use. The embodiments recited in the present invention may be treated equally, and the scope of the present invention is not limited these embodiments. Anyone who is skilled in the prior art can make modification to any parameters of the human recognition module 130 or choose alternates in flexible way if necessary.

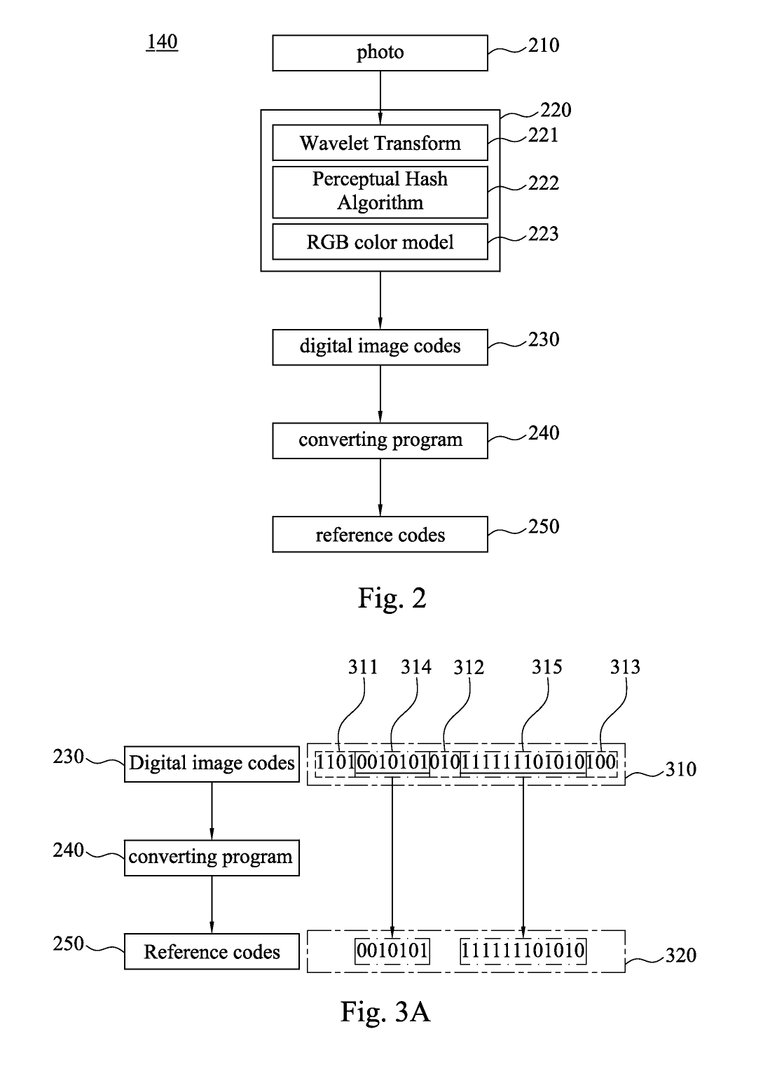

As mentioned in aforementioned embodiments, with image analysis techniques and algorithm, the photos may be converted into digital image codes by the photo operating module 140 based on parameters such as color histogram, color codes, image resolution, and brightness. Some specific string of binary data of the digital image codes will be deleted by algorithm so the digital image codes excluding the specific binary data may be used as the reference codes corresponding to each photo. FIG. 2 is a block diagram illustrating the photo operating module 140 according to one embodiment of the present invention. As shown in FIGS. 1 and 2, the photo operating module 140 of the photo grouping system 100 uses image converting method 220 such as Wavelet Transform 221, Perceptual Hash Algorithm 222, RGB color model 223, and other available image processing algorithm or their combination to convert the photos 210 so that a plurality of digital image codes 230 are obtained. Besides, with removing the specific binary data from the digital image codes 230, we can get a plurality of reference codes 250. Wavelet Transform 221, Perceptual Hash Algorithm 222, and RGB color model 223 are widely used in image processing algorithms, and detailed description on these mage processing algorithms are omitted. The photo operating module 140 may use one of Wavelet Transform 221, Perceptual Hash Algorithm 222, and RGB color model 223 to convert the photos 210 into the digital image codes 230. Actually, if the photo operating module 140 uses Wavelet Transform 221, Perceptual Hash Algorithm 222, and RGB color model 223, much more accurate result will be available. It is noted that image processing algorithms may be modified or adjusted for practical use. The embodiments recited in the present invention may be treated equally, and the scope of the present invention is not limited these embodiments. Anyone who is skilled in the prior art can make modification to image processing algorithms or choose alternates to convert photos into digital image codes in flexible way if necessary.

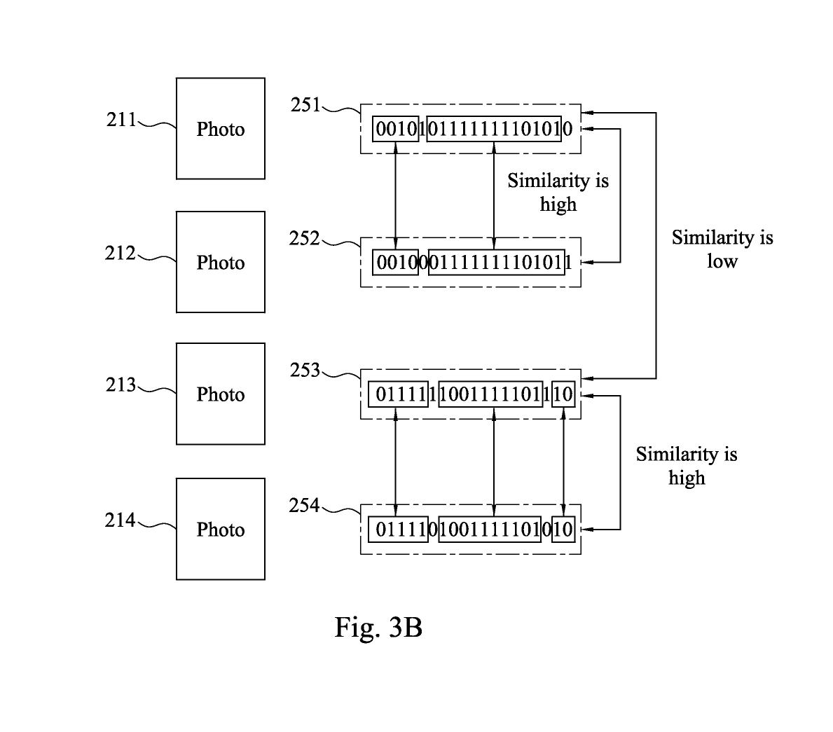

Based on EXIF data of the photos 210, the image converting method 220 converts the photo 210 into the digital image codes 230. FIG. 3A is a schematic illustrating how the photo operating module 140 converts the digital images into reference codes according to one embodiment of the present invention. As shown in FIGS. 2 and 3A, the digital image codes 230 of the photos 210 consist of binary data 310 such as “0” and “1”. The binary data 310 of the photos 210 may have identical segments such as strings 311, 312, and 313 at specific positions. Because each of the photos 210 has strings 311, 312, and 313 at specific positions, it is not helpful to recognize the photos. Even worse, it still takes time to convert the photos into reference codes including the identical segments. Thus, a converting program 240 removes the strings 311, 312, and 313 of the binary data 310 before the photos are converted into reference codes. The converting program 240 may be implemented in terms of software, hardware or combination. After removing the strings 311, 312, and 313, the strings 314 and 315 are remnant. The photo operating module 140 assembles the strings 314 and 315 into a new binary data 320, and the new binary data 320 are the reference codes 250 of each of the photos 210.

As mentioned in the foregoing embodiments, although the reference codes 250 of each of the photos 210 will not be necessary the same, the reference codes 250 which are converted from the photos 210 taken in the same scenic spot have high similarity. The way how to determine similarity of the photos 210 is to compare the binary data 320 corresponding to different photos 210. If the characters “0” or “1” of binary data 320 of any two of the photos 210 at the same position have more data or character in common, it means that similarity of the photos is much higher. To the contrary, the similarity of the photos 210 is much lower. The photo grouping module 150 as shown in FIG. 1 uses the similarity of the reference codes 250 to categorize the photos 210 into different groups by scenic spots. For example, FIG. 3B is a schematic illustrating how the photo operating module compares similarity among the reference codes of the digital images according to one embodiment of the present invention. As shown in FIG. 3B, the reference code 251 corresponds to the photo 211, and the reference code 252 corresponds to the photo 212. Likely, the reference code 253 corresponds to the photo 213, and the reference code 254 corresponds to the photo 214. After comparing the reference codes 251, 252, 253, and 254 in round-robin fashion, the reference codes 251 and 252 have more characters “0” or “1” in common at the same position, and however, the reference codes 253 and 254 have less characters “0” or “1” in common at the same position. Thus, similarity between the photo 211 corresponding to the reference code 251 and the photo 212 corresponding to the reference code 252 is higher than those between the photos 211 and 213 or those between the photos 211 and 214. Likely, similarity between the photo 213 corresponding to the reference code 253 and the photo 214 corresponding to the reference code 254 is also high. The photo grouping module 150 as shown in FIG. 1 uses the similarity of the reference codes 251, 252, 253, and 254 to categorize the photos 211, 212, 213, and 214 into two groups. Besides, because of different scenic spots, the photos 211 and 212 are categorized to one group, and the photos 213 and 214 are categorized to the other group.

After the photos 210 are categorized into different groups by similarity of the reference code 250, the landmark searching module 160 as shown in FIG. 1 compares one or more photos of photo groups with built-in landmark database. The landmark photos also include related information such as landmark, capture time, and photo sources. As shown in FIG. 1, according to one embodiment, the photo grouping system 100 further includes a local database 161 which saves landmark photos and associated landmark names. The local database 161 of the embodiment saves all photos which are imported from the photo grouping system 100 and saved as the landmark photos. Each of the landmark photos has been identified and given a landmark name by the landmark determining module 170. By searching the photos saved in the local database 161, the landmark searching module 160 determines the landmark name corresponding to the photo groups. Techniques related to determines the landmark names of the photo groups base on the landmark photos are illustrated in the foregoing embodiments so detailed description is omitted.

The landmark photos which are saved at the local database 161 are imported from the photo grouping system 100. While the landmark searching module 160 cannot find any of the imported landmark photos which match the landmark photos of the local database 161, the landmark searching module 160 uses other database to determine the landmark name of the imported landmark photos. According to one embodiment, the landmark searching module 160 of the photo grouping system 100 searches the landmark photos at search engines such as Google to determine the landmark name of the imported landmark photos. The search engine 162 should be equipped with photo searching techniques so that based on photos of the photo groups the landmark searching module 160 uses algorithm in the search engine 162 to search the landmark photos. The algorithm may be implemented in terms of software, hardware or their combination.

Some scenery photos of the photo groups may not be identified by the landmark determining module 170 because those scenery photos may be a part of building in close-up, animal photos, sky photos or even meaningless photos which are taken by inadvertently pushing camera button. These scenery photos are called undetermined photos. According to the embodiment, the landmark determining module 170 fails to determine landmark names corresponding to one or more undetermined photos, the landmark determining module 170 may refer image property of the undetermined photos, and saves the undetermined photos and corresponding image property at the local database 161. Users may be allowed to edit the image property, and adds the landmark or other identification information into the undetermined photos. Users can decide how to deal with the undetermined photos based on different situations.

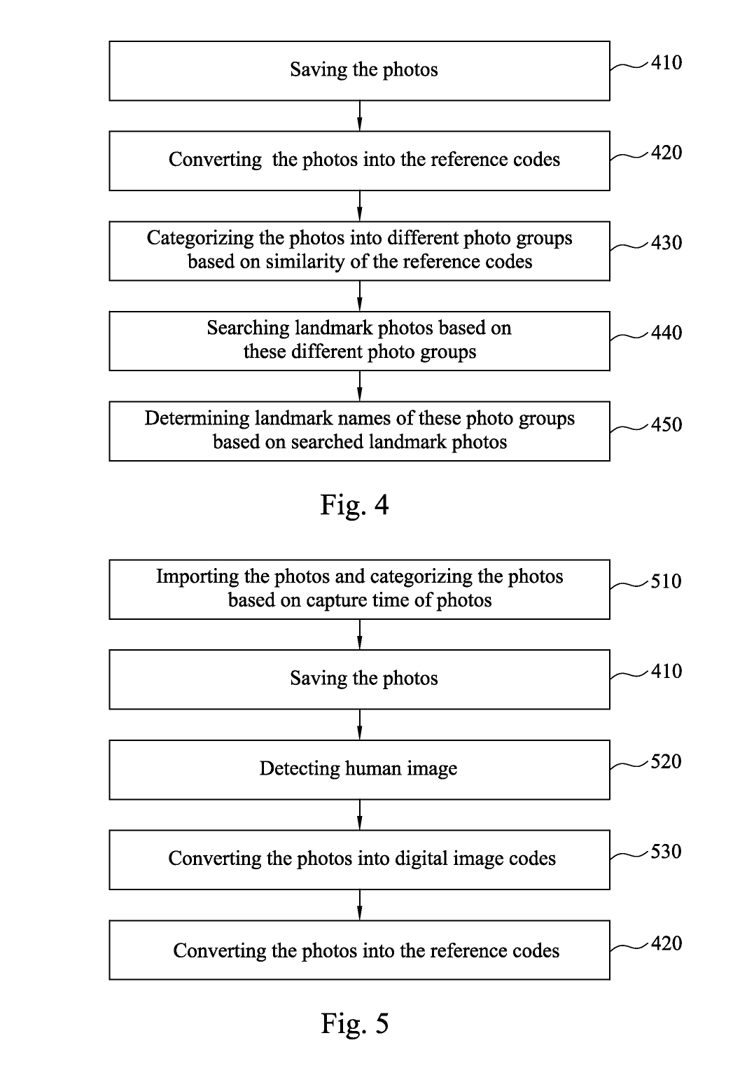

FIG. 4 is a flow chart illustrating a photo grouping method according to one embodiment of the present invention. As shown in FIG. 4, the photo grouping method of the present invention includes steps 410˜450. It is noted that steps of the photo grouping method as recited in the embodiment may be adjusted in terms of step sequence for practical use except that the step sequence is significantly addressed, and all or part of steps may be concurrently executed. Hardware for using the photo grouping method is disclosed in the foregoing embodiment, and description is omitted.

Practically, the photo grouping method may be executed by an internet server or a website, and may be implemented in terms of a computer program which is saved at a non-transitory computer-readable storage medium. Thus, computer may access the non-transitory computer-readable storage medium so as to have the internet server or the website execute the photo grouping method.

In step 410, a plurality of photos are saved. In step 420, the photos are converted into corresponding reference codes. In step 430, the photos are categorized into different photo groups based on similarity of the reference codes. In step 440, the landmark photos are searched based on these different photo groups. In step 450, the landmark names of these photo groups are determined based on searched landmark photos.

FIG. 5 is a flow chart illustrating a photo grouping method according to another embodiment of the present invention. As shown in FIG. 5, in step 510 before step 410, the photos may be imported by an import module (e.g., a photo import platform at web pages, an application program implemented at computer, an APP implemented at mobile device, or a multimedia kiosk at convenient stores). The photos may be categorized by capture time (e.g., date and time information) of the photos in EXIF into different groups.

In step 520, human image of the photos are detected by the edge detection algorithm, the skin color detection algorithm, and the ellipsoid method in sequence. The method how to execute human detection method is illustrated in the foregoing embodiment, and description is omitted. If the percentages of human figures to photo area of the photos exceed a predetermined percentage (e.g., 50%), then these photos will be removed and will not be converted into corresponding reference codes. While the photos are imported from the import module, the photos may be categorized by capture time of EXIF. The photos which have the percentages of human figures to photo area exceeding a predetermined percentage are categorized.

In step 530, the image converting methods such as Wavelet Transform, Perceptual Hash Algorithm, RGB color model, and other available image processing algorithm or their combination are used to calculate and convert the photos so as to get a plurality of digital image codes. Besides, with removing the identical segments from the digital image codes, we can get a plurality of reference codes. Wavelet Transform, Perceptual Hash Algorithm, and RGB color model are widely used in image processing algorithms, and detailed description on these mage processing algorithms are omitted. In step 530, one of Wavelet Transform, Perceptual Hash Algorithm, and RGB color model may be used to convert the photos into the digital image codes. Actually, if all of Wavelet Transform, Perceptual Hash Algorithm, and RGB color model are used, much more accurate result will be available. It is noted that image processing algorithms may be modified or adjusted for practical use. The embodiments recited in the present invention may be treated equally, and the scope of the present invention is not limited these embodiments. Anyone who is skilled in the prior art can make modification to image processing algorithms or choose alternates to convert photos into digital image codes in flexible way if necessary.

The method to convert the digital image codes into the reference codes is illustrated in terms of embodiments, and description is omitted. After the photos are categorized into a plurality of photo groups according to similarity of the reference codes, one or more photos of the photo groups may be compared with the landmark photos which are built in the database. Besides, the landmark photos further includes related information. As shown in FIG. 4, in step 440, the landmark names of these photo groups are determined based on searched landmark photos. The local database of the embodiment saves all imported photos via the photo grouping method, and these imported photos are saved as landmark photos and include landmark names.

In step 440, the photo grouping method may search the landmark photos at searching engines (e.g., Google) to determine the landmark name of the imported landmark photos. The searching engine should be equipped with photo searching techniques so that algorithm is used in the searching engine to search the landmark photos based on photos of the photo groups. The algorithm may be implemented in terms of software, hardware or their combination. Some scenery photos of the photo groups may not be identified, and these scenery photos are called undetermined photos. According to the embodiment, the landmark determining module fails to determine landmark names corresponding to one or more undetermined photos, image property of the undetermined photos may be referred and the undetermined photos and corresponding image property are saved at the local database. Users may be allowed to edit the image property, and adds the landmark or other identification information into the undetermined photos. Users can decide how to deal with the undetermined photos based on different situations.

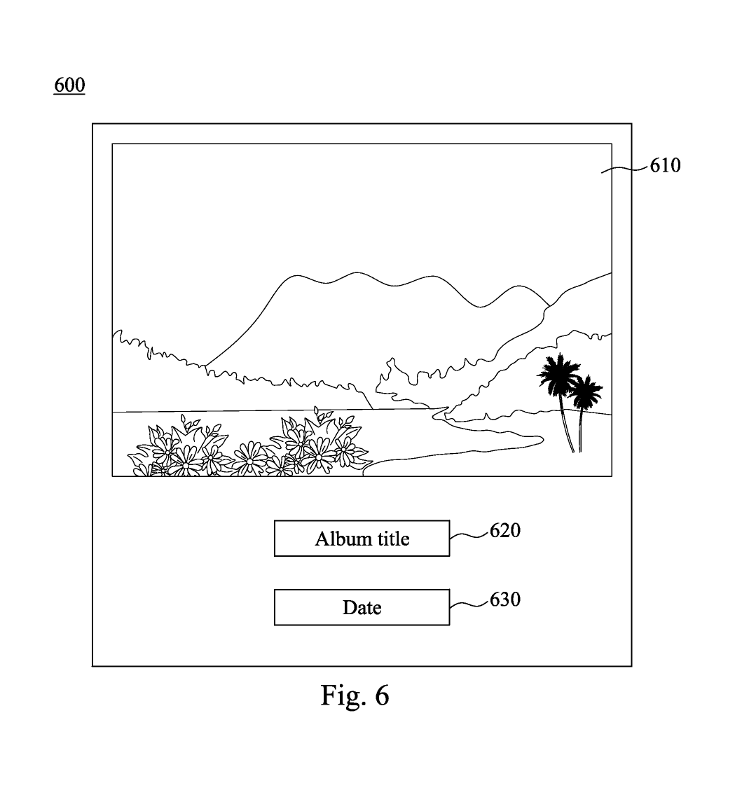

FIG. 6 is a flow chart illustrating how a photo grouping system and a grouping method are implemented according to one embodiment of the present invention. As shown in FIGS. 1, 4, and 6, the present invention discloses a photo grouping system and a photo grouping method for web albums. The web albums are installed at website through Internet or cloud storage space, and the photos of the web albums are obtained from the photo database 120. According to the photo grouping system and the photo grouping method of the present invention, the photos are imported to the photo database 120 via the import module 110 so as to automatically configure detailed information of the web albums. Cover photos 610 of the web album covers 600 are usually scenery photos or portrait photos. While the number of the scenery photos exceeds that of the portrait photos, one of scenery photos is selected from of photo groups and saved as the cover photo 610. While the number of the portrait photos exceeds that of the scenery photos, one of portrait photos is selected from of photo groups and saved as the cover photo 610. By default, web album title 620 may be the landmark where most photos of the photos groups are taken and determined by the photo grouping module 150 and the landmark searching module 160. The web album title 620 may be chosen by users. A date 630 by default may be the capture time of the EXIF of the photos, or date 630 may be filled up by users.

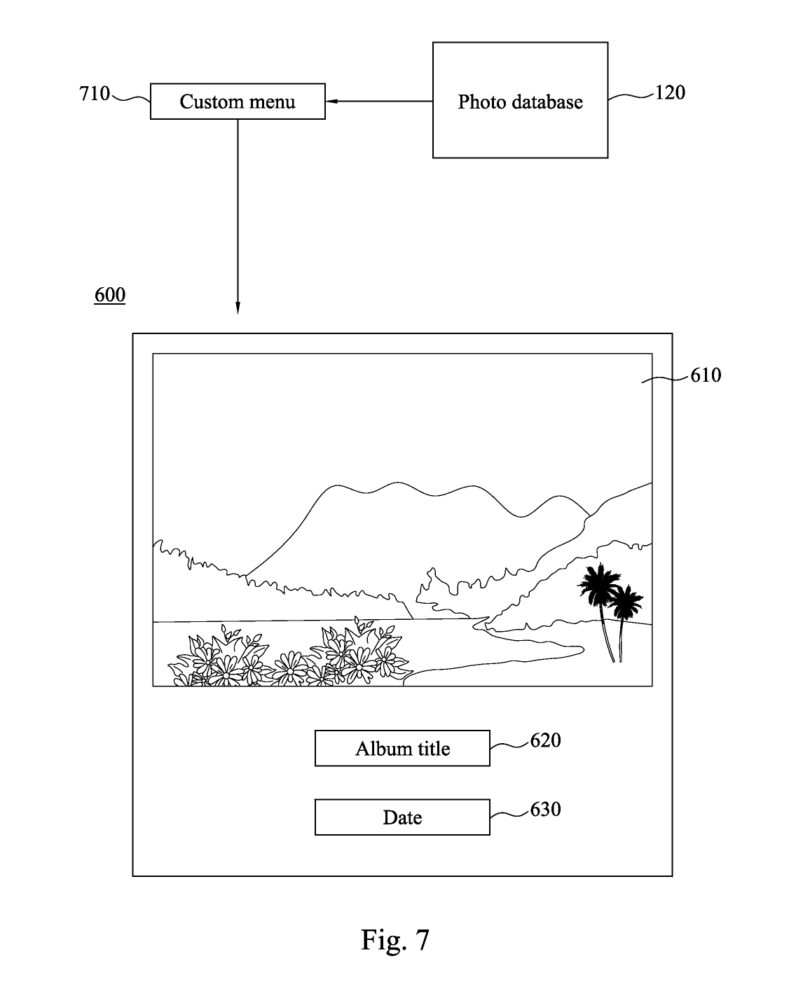

FIG. 7 is a flow chart illustrating how a photo grouping system and a grouping method are implemented according to another embodiment of the present invention. As shown in FIGS. 1, 4, and 7, the present invention discloses a photo grouping system and a photo grouping method for customizing web albums. A custom menu 710 is accessible for user through internet or cloud storage space, and the user choose the photo landmark and place them at the web album via the custom menu 710. User can use the custom menu 710 to choose himself/herself photos and fill up keywords to the custom menu 710 so that the photo grouping system will choose compatible photos at the photo database 120 based on configuration of the custom menu 710. Thus, as shown in FIG. 6, the required information of the photos for automatically configuring the web albums is obtained. The method how to execute web album is illustrated at the foregoing embodiments, and description is omitted. It is noted that the foregoing examples or alternates should be treated equally, and the present invention is not limited to these examples or alternates. Anyone who is skilled in the prior art can make modification to these examples or alternates in flexible way if necessary.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A photo grouping system, comprising:
a photo database, saving a plurality of photos;
a photo operating module, converting the photos into a plurality of reference codes;
a photo grouping module, categorizing the photos into a plurality of photo groups according to similarity of the reference codes;
a landmark searching module, searching a landmark photo base on the photo groups; and
a landmark determining module, determining landmark names of the photo groups base on the landmark photos which are searched by the landmark searching module.

2. The photo grouping system of claim 1, further comprising:
an import module, importing the photos and based on capture time of the photos in EXIF categorizing the photos into groups.

3. The photo grouping system of claim 1, further comprising:
a human recognition module, detecting human portrait of the photos, and wherein if the percentages of human figures to photo area of one or more portrait photos exceed a predetermined percentage, then the human recognition module removes these portrait photos.

4. The photo grouping system of claim 3, wherein the predetermined percentage is 50%.

5. The photo grouping system of claim 1, wherein the photo operating module uses one of Wavelet Transform, Perceptual Hash Algorithm, and RGB color model or their combination to convert the photos into a plurality of digital image codes and remove the identical segments from the digital image codes so as to get reference codes.

6. The photo grouping system of claim 1, wherein the landmark searching module searches the landmark photos at a search engine to determine the landmark name of the imported landmark photos.

7. The photo grouping system of claim 1, further comprising:
a local database, saving the landmark photos and associated landmark names, and wherein the landmark searching module searches the landmark photos which are saved at the local database to determine the landmark name of the imported landmark photos.

8. The photo grouping system of claim 7, wherein while the landmark determining module fails to determine landmark names corresponding to one or more undetermined photos, the landmark determining module refers image property of the undetermined photos and saves the undetermined photos and corresponding image property at the local database.

9. A photo grouping method, comprising:
(a) saving a plurality of photos;
(b) converting the photos into corresponding reference codes;
(c) categorizing the photos into different photo groups based on similarity of the reference codes;
(d) searching landmark photos based on these different photo groups; and
(e) determining landmark names of these photo groups based on searched landmark photos.

10. The photo grouping method of claim 9, further comprising:
importing the photos to the photo database via a import module and categorizing the photos based on capture time of EXIF of the photos.

11. The photo grouping method of claim 9, further comprising:
detecting a plurality of the portrait photos of the photos; and
wherein if the percentages of human figures to photo area of one or more photos exceed a predetermined percentage, then these portrait photos with the percentages of human figures to photo area exceeding a predetermined percentage are removed.

12. The photo grouping method of claim 11, wherein the predetermined percentage is 50%.

13. The photo grouping method of claim 9, wherein the step (b) comprises:
using Wavelet Transform, Perceptual Hash Algorithm, RGB color model, and other available image processing algorithm or their combination to calculate and convert the photos so as to get a plurality of digital image codes and removing the identical segments from the digital image codes so as to get reference codes.

14. The photo grouping method of claim 9, further comprising:
searching the landmark photos at the search engine to determine the landmark names of the photo groups.

15. The photo grouping method of claim 9, further comprising:
searching the landmark photos which are saved at the local database to determine the landmark names of the photo groups.

16. The photo grouping method of claim 15, further comprising:
referring to image property of the undetermined photos and saving the undetermined photos and corresponding image property at the local database while the landmark determining module fails to determine landmark names corresponding to one or more undetermined photos.

17. A non-transitory computer-readable storage medium for storing computer programs to execute a photo grouping method, the method comprising:
saving a plurality of photos;
converting the photos into corresponding reference codes;
categorizing the photos into different photo groups based on similarity of the reference codes;
searching landmark photos based on these different photo groups; and
determining landmark names of these photo groups based on searched landmark photos.
